(19) United States
(12) Patent Application Publication
(10) Pub. No.: US 2025/0244646 A1
(43) Pub. Date: Jul. 31, 2025

(54) VEHICULAR PROJECTION DISPLAY AT WINDOW OF VEHICLE

(71) Applicant: Magna Exteriors, Inc., Troy, MI (US)

(72) Inventors: David K. Johnson, Holland, MI (US); Darin J. Snider, Holland, MI (US); Steven P. Goodwin, Pullman, MI (US)

(21) Appl. No.: 19/032,569

(22) Filed: Jan. 21, 2025

Related U.S. Application Data
(60) Provisional application No. 63/624,811, filed on Jan. 25, 2024.

(51) Int. Cl. G03B 21/14; B60Q 1/50; B60R 25/31

(52) U.S. Cl. CPC G03B 21/145; B60Q 1/503; B60Q 1/543; B60R 25/31; B60R 2325/205

(57) ABSTRACT

A vehicular display system includes a projection device disposed within an interior cabin of a vehicle. The projection device is operable to project information toward an inner side of a window panel of the vehicle for viewing of the projected information by a person outside of the vehicle. Responsive at least in part to determination of presence of an authorized user outside of the vehicle and at or near the window panel of the vehicle, the projection device projects information for viewing by the authorized user of the vehicle.

### CROSS REFERENCE TO RELATED APPLICATION

The present application claims the filing benefits of U.S. provisional application Ser. No. 63/624,811, filed Jan. 25, 2024, which is hereby incorporated herein by reference in its entirety.

### FIELD OF THE INVENTION

The present invention relates to display systems for vehicles and, more particularly to displays viewable exterior of a vehicle.

### BACKGROUND OF THE INVENTION

It is known to provide a numeric keypad (for locking/unlocking a door) at the B-pillar of the door or vehicle. It is also known to locate a display at an inner side of a window panel of a vehicle for viewing by a person exterior the vehicle.

### SUMMARY OF THE INVENTION

A vehicular projection display system is disposed within an interior cabin of a vehicle. The vehicular projection display system includes a projector device that is operable to project images at an inner side of a window panel of the vehicle, so that a person (such as, for example, an authorized user of the vehicle, such as the owner of the vehicle) may view the displayed images from outside of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle having a vehicular projection display system; and

FIG. 2 is a perspective view of the vehicular projection display system of FIG. 1.

### DESCRIPTION OF THE PREFERRED EMBODIMENTS

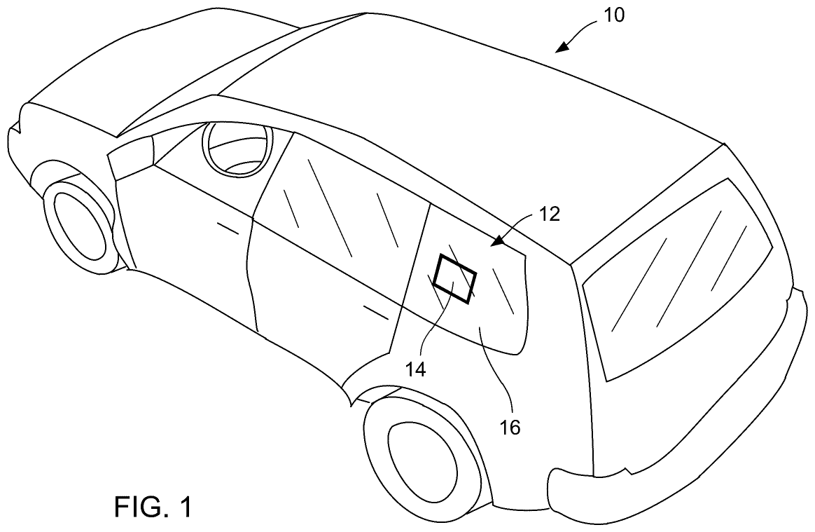

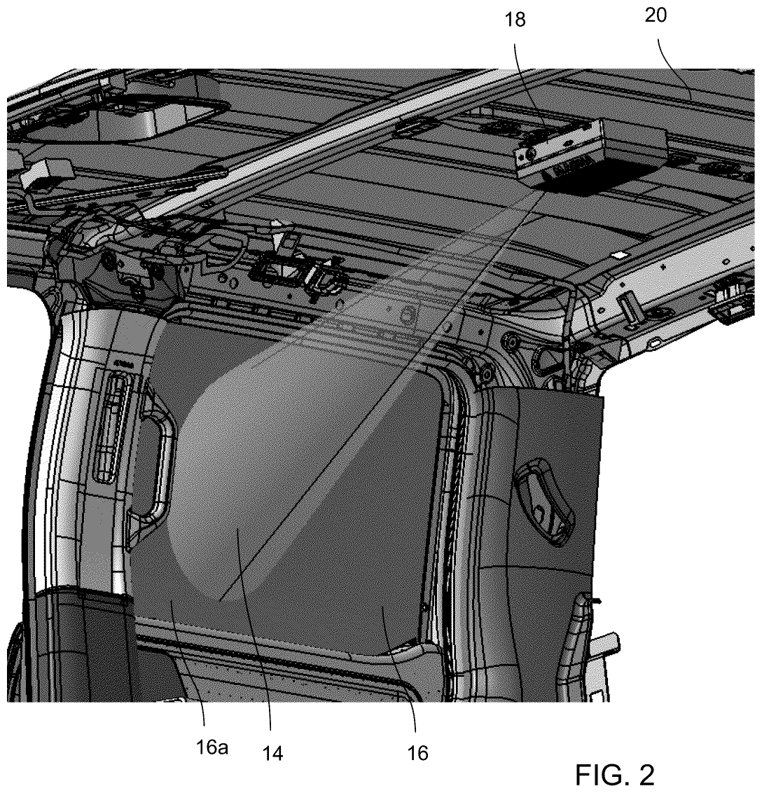

Referring now to the drawings and the illustrative embodiments depicted therein, a vehicle 10 includes a vehicular projection display system 12 that projects images at a display region 14 of a window panel 16 of the vehicle (FIG. 1). The display system 12 is operable to display information at the side of the vehicle by projecting the information at an inner side 16a of the window panel 16 via a projection device 18 (FIG. 2). The display system may utilize aspects of the window assemblies described in U.S. Pat. Nos. 10,668,868; 10,559,153; 10,427,503 and/or 9,896,026, and/or U.S. Publication No. US2023/0150343, and/or International Application No. PCT/US2024/036317, filed Jul. 1, 2024 (Attorney Docket DON02 FP5157WO), which are all hereby incorporated herein by reference in their entireties.

The projection device 18 may comprise a display screen (e.g., a backlit liquid crystal display (LCD) display screen or a backlit thin film transistor (TFT) LCD display or any suitable display screen that is backlit by a plurality of light emitting diodes or OLEDs or QLEDs or the like) that is backlit to project the displayed information on the inner side of the window panel. The display system is operable to display various information, such as responsive to detection of user or responsive to user input at the window panel, such as via a gesture recognition, or at a display/touch screen at the side of the vehicle. The system or vehicle (e.g., a body control module or door control module or electronic control unit (ECU) at the vehicle) may control the selected function or feature or accessory responsive to the user input, such as when the user makes a particular gesture or hand movement or when the user touches an appropriate region of the window panel or vehicle. For example, the user can lock/unlock/open/close one or more or all of the doors of the vehicle, lock/unlock/open/close a charge port/fuel port of the vehicle, open/close windows and/or a sunroof of the vehicle, etc. via gestures or other inputs. The user may also or otherwise activate the lights and/or hazard lights and/or an alarm or horn of the vehicle via other user inputs. Optionally, the user may start or turn on the vehicle and/or may stop or turn off the vehicle via gestures or inputs.

Optionally, the display system may work with or connect with the user's smart phone, whereby the smart phone and the display system may both operate to control the various features or functions or accessories. The display system may display what may be shown on the user's phone, such as what is displayed on the phone screen when the user has opened an app associated with their vehicle. Thus, the user can access the app controls (e.g., lock, unlock, start, lights, hazards, climate control, trunk or decklid or liftgate lock/unlock/open, horn, etc.) at the display region, such as based at least in part on an output of a camera or light sensor or radar sensor that may sense the proximity of the user's hand and finger, without using their smart phone when the user is located at the side of the vehicle. Optionally, the user can make appropriate gestures at or near the display region, such as based at least in part on determining movement of the user's hand based at least in part on an output of a camera or light sensor or radar sensor, without using their smart phone when the user is located at the side of the vehicle.

The display system may operate responsive to presence of the user or person at the side of the vehicle. For example, the display system may operate responsive to a signal from a passive device or from the user's smart phone or the like. Optionally, the display system may operate responsive to determination that the person exterior the vehicle is an authorized user of the vehicle, such as responsive to a keyfob or the user's smart phone or the like. Optionally, as the identified authorized user approaches, the display system may operate to display a greeting to the user, and may also or otherwise display information, such as vehicle status or alert (e.g., battery charge or fuel tank level, a lock/unlock status, tire pressure, particularly if one or more tires has low pressure) and/or temperature at or in the vehicle, and/or the like. Optionally, the display system may ask for an additional security measure, such as a passcode or biometric identification or the like, before allowing the user to access the vehicle.

The projection device 18 is operable to project light and images toward the display region of the window panel. The window panel, at least at the display region, may have a coating or film disposed thereat (such as at the inner side of the window panel) that enhances viewing of the displayed images or information by a person exterior of the vehicle. For example, the film or layer may be selected to accept the projection and allow transmission of the visible light from the projector to pass through the window panel at the display region. The film or layer may, for example, comprise a transparent metallic coating (e.g., a very thin layer of silver or other suitable metal, such as a thin layer having a thickness of less than 100 nm, such as around 50 nm or less). The film or layer may be disposed at the display location and in a selected shape so that the displayed information, when the projection device is operating to project information, is clear and substantially viewable at that location. The other locations or regions of the window panel that do not have the film or layer may not allow for the light projected by the projection device to pass through the window panel or may attenuate light projected by the projection device. Thus, the light or image or information projected at the thin film coated display region at the inner side of the window panel is readily viewable by a person exterior the vehicle that is viewing the window panel. When the projection device is not operating to project light or images or information, the display region is rendered covert to the person exterior the vehicle.

The projection device may be disposed at any suitable location within the vehicle. For example, and such as shown in FIG. 2, the projection device 18 may be disposed at a roof or upper panel 20 of the vehicle 10. Although shown as exposed and not-covered at the upper panel of the vehicle, the headliner of the vehicle (not shown in FIG. 2) that is disposed at and conceals the upper panel of the vehicle may also cover and conceal the projection device from view by a person within the vehicle. For example, the projection device may mount to a metal structure (e.g., frame or sheet metal) of the vehicle (as shown in FIG. 2), and then the headliner and/or other roof trim components may be installed to at least partially encase and/or cover the projection device, providing an opening through which the images are projected. The projection device may attach at the roof panel via any suitable means, such as, for example, via fasteners or snap attachment or adhesive.

The window panel at which the information is projected may comprise a side window of the vehicle, such as a fixed side window panel toward the rear of the vehicle, or such as a rear window or backlite of the vehicle. Optionally, because the projection device is located remote from the window panel, the window panel at which the information is projected may comprise a movable side window panel, such as a tiltable or openable rearward side window panel or such as a raisable and lowerable window panel of a side door of the vehicle. When the display region is at a movable window panel, the projection device may be controlled in part based on the status of the window panel. In other words, the projection device may only operate to project information when the window panel is closed and when the display region is at the appropriate location and orientation for the projection of information. The status of the window panel may be determined via one or more sensors at the vehicle and optionally may be communicated to the display system via a vehicle bus or cable or wire harness.

The projection device projects information in a manner that is viewable through the window panel and that is in an appropriate orientation for such viewing. In other words, the projected information is a mirror image of what would be projected if intended to view the reflection of the projected information at the window panel.

The display system may be electrically connected to a power source of the vehicle, and may be in communication (such as via a communication bus of the vehicle) with the various systems or accessories of the vehicle (or to an electronic control unit (ECU) of body control module or door control module that controls one or more of the systems or accessories. Optionally, the projection device may include its own power source (such as a battery disposed at the lower portion of the device), and may communicate wirelessly with the vehicle door lock system (and/or other systems of the vehicle) via a short range communication protocol, such as BLUETOOTH® or the like.

Optionally, a sensing system of the display system may include “gesture” technology so that the device can detect an authorized user's (such as a person carrying a key fob for the vehicle) hand wave or other gesture, and can unlock/lock the door accordingly (and/or generate other outputs to perform other functions responsive to recognition of the user's gesture). The sensing device thus may include one or more other sensors (such as imaging sensors or radar sensors or lidar sensors or light sensors or the like) that are disposed behind and view or sense through an aperture or window of a non-light-transmitting layer of the window panel, so as to sense the presence and movement of a person's hand or the like at or near the door or window, such as by utilizing aspects of the window assemblies described in U.S. Publication No. US-2018-0094471, which is hereby incorporated herein by reference in its entirety.

The sensing system may comprise any suitable sensors, such as the types of touch sensitive elements and/or proximity sensors described in U.S. Pat. Nos. 5,594,222;6,001,486; 6,310,611; 6,320,282; 6,627,918; 7,224,324; 7,249,860; 7,253,723; 7,446,924;9,346,403 and/or 9,598,016, and/or U.S. Publication No. US-2006-0050018, which are hereby incorporated herein by reference in their entireties, or such as sensors of the types described in U.S. Pat. Nos. 7,255,541; 6,504,531; 6,501,465; 6,492,980; 6,452,479;6,437,258 and/or 6,369,804, which are hereby incorporated herein by reference in their entireties.

Optionally, the window assembly or assemblies of the present invention may utilize aspects of the window assemblies described in U.S. Pat. Nos. 8,881,458;8,402,695; 5,853,895; 5,551,197; 7,073,293; 7,003,916 and/or 6,691,464, and/or U.S. Publication Nos. US-2017-0066305; US-2014-0170357; US-2006-0107600; US-2008-0127563; US-2004-0020131 and/or US-2003-0213179, which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A vehicular display system, the vehicular display system comprising:
a projection device disposed within an interior cabin of a vehicle;
wherein the projection device is operable to project information toward an inner side of a window panel of the vehicle for viewing of the projected information by a person outside of the vehicle; and
wherein, responsive at least in part to determination of presence of an authorized user outside of the vehicle and at or near the window panel of the vehicle, the projection device projects information for viewing by the authorized user of the vehicle.

2. The vehicular display system of claim 1, wherein the projection device is disposed at a roof panel of the vehicle.

3. The vehicular display system of claim 1, wherein the vehicular display system determines presence of the authorized user outside of the vehicle responsive to a proximity sensor at the vehicle.

4. The vehicular display system of claim 1, wherein the vehicular display system determines presence of the authorized user outside of the vehicle responsive to a passive entry device of the authorized user.

5. The vehicular display system of claim 1, wherein the vehicular display system determines presence of the authorized user outside of the vehicle responsive to a signal from the authorized user's smart phone.

6. The vehicular display system of claim 1, wherein the vehicular display system operates the projection device responsive to identification of a person as the authorized user of the vehicle.

7. The vehicular display system of claim 1, wherein the window panel comprises a fixed side window panel of the vehicle.

8. The vehicular display system of claim 1, wherein the window panel comprises a movable side window panel of the vehicle.

9. The vehicular display system of claim 8, wherein operation of the projection device is controlled in part based on an opened/closed status of the movable side window panel.

10. The vehicular display system of claim 1, wherein the window panel comprises a rear window panel of the vehicle.

11. The vehicular display system of claim 1, wherein the projected information comprises a vehicle status.

12. A vehicular display system, the vehicular display system comprising:
a projection device disposed at a roof panel within an interior cabin of a vehicle;
wherein the projection device is operable to project information toward an inner side of a window panel of the vehicle for viewing of the projected information by a person outside of the vehicle;
wherein, responsive at least in part to determination of presence of a person outside of the vehicle, the person is identified as an authorized user of the vehicle; and
wherein, responsive at least in part to identification of the authorized user outside of the vehicle and at or near the window panel of the vehicle, the projection device projects information for viewing by the authorized user of the vehicle.

13. The vehicular display system of claim 12, wherein the vehicular display system determines presence of the person outside of the vehicle responsive to a proximity sensor at the vehicle.

14. The vehicular display system of claim 12, wherein the vehicular display system determines presence of the person outside of the vehicle responsive to a passive entry device of the authorized user.

15. The vehicular display system of claim 12, wherein the vehicular display system determines presence of the person outside of the vehicle responsive to a signal from the authorized user's smart phone.

16. The vehicular display system of claim 12, wherein the window panel comprises a fixed side window panel of the vehicle.

17. The vehicular display system of claim 12, wherein the window panel comprises a movable side window panel of the vehicle, and wherein operation of the projection device is controlled in part based on an opened/closed status of the movable side window panel.

18. The vehicular display system of claim 12, wherein the window panel comprises a rear window panel of the vehicle.

19. The vehicular display system of claim 12, wherein the projected information comprises a vehicle status.

20. A vehicular display system, the vehicular display system comprising:
a projection device disposed within an interior cabin of a vehicle;
wherein the projection device is operable to project information toward an inner side of a window panel of the vehicle for viewing of the projected information by a person outside of the vehicle;
wherein a person present outside of the vehicle is detected via at least one selected from the group consisting of (i) a passive entry device of the person, (ii) a signal from the person's smart phone, and (iii) a proximity sensor of the vehicle;
wherein, responsive at least in part to detection of the person outside of the vehicle, the person is identified; and
wherein, responsive at least in part to identification of the detected person as an authorized user, and responsive to determination that the authorized user is at or near the window panel of the vehicle, the projection device projects information for viewing by the identified authorized user of the vehicle.

21. The vehicular display system of claim 20, wherein the projection device is disposed at a roof panel of the vehicle.

22. The vehicular display system of claim 20, wherein the window panel comprises a fixed side window panel of the vehicle.

23. The vehicular display system of claim 20, wherein the window panel comprises a movable side window panel of the vehicle, and wherein operation of the projection device is controlled in part based on an opened/closed status of the movable side window panel.

24. The vehicular display system of claim 20, wherein the window panel comprises a rear window panel of the vehicle.

25. The vehicular display system of claim 20, wherein the projected information comprises a vehicle status.
